(19) United States
(12) Patent Application Publication
(10) Pub. No.: US 2026/0244903 A1
(43) Pub. Date: Aug. 20, 2026

(54) MODIFIED CONVOLUTION PARAMETERS TO AVOID REQUANTIZING OPERATIONS

(71) Applicant: QUALCOMM Incorporated, San Diego, CA (US)

(72) Inventors: Changzhou HE, Shanghai (CN); Xiaolin GU, Shanghai (CN); Xun JIANG, Shanghai (CN); Yifei ZHANG, San Diego, CA (US)

(21) Appl. No.: 19/164,373

(22) PCT Filed: May 1, 2023
(86) PCT No.: PCT/CN2023/091930

§ 371 Date: Sep. 11, 2025

(51) Int. Cl. G06N 3/0464; G06N 3/0495

(52) U.S. Cl. CPC G06N 3/0464; G06N 3/0495

(57) ABSTRACT

Certain aspects of the present disclosure provide techniques and apparatus for improved machine learning. A first quantized tensor (205A) quantized according to a first set of quantization parameters (215A) and a second quantized tensor (205B) quantized according to a second set of quantization parameters (215B) are concatenated to generate a concatenated tensor (270). A first set of convolution parameters (270), generated for at least one layer of a first machine learning model based on the first and second sets of quantization parameters (215A, 215B) and a second set of convolution parameters (230) for at least one layer of a second machine learning model (202), is accessed. A convolution output (275) for the at least one layer of the first machine learning model (252) is generated based on convolving the first set of convolution parameters (270) with the concatenated tensor (260).

### INTRODUCTION

Aspects of the present disclosure relate to machine learning.

Various machine learning architectures have been used to provide solutions for a wide variety of computational problems. For example, a wide variety of neural network architectures have been developed to perform tasks such as image processing, natural language processing, and the like. Some machine learning architectures use quantization to reduce the computational resources used during inferencing. For example, along with quantizing the weights of the model, the activations and other tensors generated during inferencing may be quantized to reduce memory footprint.

Additionally, in many modern architectures, concatenation operations are used in various places in the model to concatenate inputs prior to convolution operations, matrix multiplication operations, and/or fully connected layer operations (e.g., in convolutional neural networks, natural language processing (NLP) models, and the like). In at least some conventional architectures, when the input tensors are quantized, the tensors are first requantized prior to concatenation. That is, because the tensors are generally quantized using distinct parameters, the tensors are requantized to a shared set of quantization parameters before the tensors can be meaningfully concatenated. This requantization operation consumes substantial computational resources, reducing the benefits of quantizing in the first place.

### BRIEF SUMMARY

Certain aspects of the present disclosure provide a processor-implemented method, comprising: concatenating a first quantized tensor quantized according to a first set of quantization parameters and a second quantized tensor quantized according to a second set of quantization parameters to generate a concatenated tensor; accessing a first set of convolution parameters generated for at least one layer of a first machine learning model based on the first and second sets of quantization parameters and a second set of convolution parameters for at least one layer of a second machine learning model; and generating a convolution output for the at least one layer of the first machine learning model based on convolving the first set of convolution parameters with the concatenated tensor.

Certain aspects of the present disclosure provide a processor-implemented method, comprising: accessing a machine learning model architecture comprising a concatenation-convolution sequence that comprises one or more requantization operations to requantize one or more input tensors to a concatenation operation; generating a modified set of convolution parameters based on a set of convolution parameters for a convolution operation of the concatenation-convolution sequence and a set of quantization parameters for the one or more input tensors; quantizing the modified set of convolution parameters; and generating a modified machine learning model architecture comprising a modified concatenation-convolution sequence that comprises a modified convolution operation using the quantized modified set of convolution parameters.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for concatenation-convolution operations in machine learning model architectures.

FIG. 2 depicts example workflows for modified concatenation-convolution operations in machine learning model architectures.

FIG. 3 depicts an example environment for modifying machine learning model architectures to reduce requantization operations.

FIG. 4 is a flow diagram depicting an example method for generating updated model architectures to eliminate requantization operations.

FIG. 5 is a flow diagram depicting an example method for using updated model architectures without requantization operations.

FIG. 6 is a flow diagram depicting an example method for generating a convolution output without requantization.

FIG. 7 is a flow diagram depicting an example method for modifying model architectures to eliminate requantization.

FIG. 8 depicts an example processing system configured to perform various aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning models that enable direct concatenation of quantized tensors while eliminating requantization operations.

In many conventional machine learning architectures, concatenation operations are used to combine tensors (e.g., activation tensors) prior to convolution operations, matrix multiplication operations, and/or fully connected layer operations. In some aspects of the present disclosure, such sequences (where the input to a convolution, matrix multiplication, and/or fully connected operation is a concatenated set of tensors) may be referred to as concatenation-convolution sequences. If these input tensors are quantized, then at least some conventional architectures involve applying requantization operations to each input tensor prior to concatenation. That is, when the input tensors are quantized according to different quantization parameters (e.g., a different scale and zero point for each), the tensors in these conventional architectures are generally requantized to a shared scale and zero point prior to concatenation.

Specifically, suppose an input tensor A is quantized according to a scale S_{A} and a zero point Z_{A}. To enable typical conventional concatenation with another tensor B quantized using a different scale S_{B} and zero point Z_{B}, both tensors are requantized according to a set of shared quantization parameters (e.g., a shared scale Sc and a shared zero point Z_{C}). In some conventional architectures, this requantization is performed using Equation 1 below, where A* is requantized tensor A using the shared quantization parameters:

$${A}^{*} = round ( \frac{( A + {Z}_{A} ) * {S}_{A}}{{S}_{C}} - {Z}_{C} ) \qquad ( 1 )$$

Equation 1 may similarly be used to requantize tensor B by replacing A* with B*, A with B, Z_{A} with Z_{B}, and S_{A} with S_{B}.

Although some mitigation techniques have been introduced to reduce the computational overhead of such requantization operations (such as using table look-ups or other optimizations), the requantization still consumes substantial resources in these conventional architectures. Additionally, requantization operations may inherently reduce the precision of the data in some aspects, affecting model accuracy.

In aspects of the present disclosure, these requantization operations can be eliminated by absorbing the quantization parameters of the input tensors into the subsequent convolution parameters offline and prior to inferencing. In some aspects, these modifications or optimizations can be applied subsequent to training and prior to inference. That is, a machine learning model having an architecture that includes one or more concatenation-convolution sequences may be trained (e.g., using training data) to learn convolution parameters (e.g., weights and/or biases). These learned convolution parameters may then be updated or modified to absorb the quantization parameters of the input tensors in such a way that the requantization operations (at least before or as part of concatenation) can be removed. The modified architecture can then be used for inferencing using the modified convolution parameters and without performing requantization operations during inference, as discussed in more detail below.

By eliminating requantization operations that are used in at least some conventional architectures before or as part of concatenation operations, aspects of the present disclosure are able to substantially improve performance (e.g., reduce latency of inference and/or increase prediction accuracy) while reducing power consumption greatly, as well as enabling use of less memory space. In some aspects, improved accuracy benefits are achieved due at least in part to the reduced requantization operations (which inherently affect precision), and/or because the convolution parameters can be updated offline accurately (e.g., in 32-bit precision). Additionally, because aspects of the present disclosure can be applied as a post-training quantization/optimization solution, such aspects do not require re-training of the model itself.

Generally, the model optimizations described herein may be applied or implemented by a variety of systems, including by a training system that trained the initial machine learning model, by an inferencing system that uses the trained initial model for inferencing, and/or by a third system acting as an intermediary that receives trained initial models from training systems, optimizes the received models to eliminate requantization operations, and provides the optimized models to inferencing systems.

### Example Workflow for Concatenation-Convolution Operations in Machine Learning Model Architectures

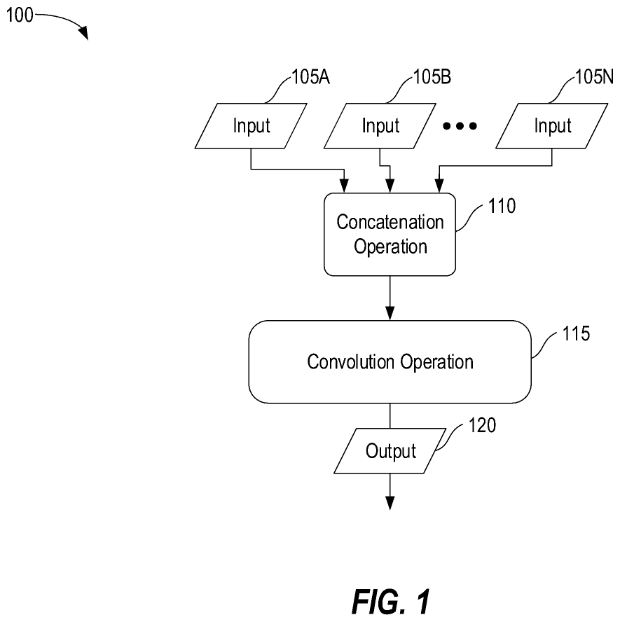

FIG. 1 depicts an example workflow 100 for concatenation-convolution operations in machine learning model architectures.

As illustrated, the workflow 100 involves a set of input tensors 105A, 105B, . . . , 105N (collectively referred to herein as “input tensors 105”) being concatenated using a concatenation operation 110, where the concatenated data (output by the concatenation operation 110) is used as input to a convolution operation 115 to generate output tensor 120. Although three input tensors 105A, 105B, and 105N are depicted for conceptual clarity, in aspects, there may be any number of input tensors 105. Additionally, though the depicted workflow 100 does not depict requantization operations, conventional architectures generally apply such requantization prior to the concatenation, as discussed below in more detail. For example, the concatenation operation 110 may itself perform requantization on each input tensor 105A-N prior to concatenation of the requantized tensors. In aspects of the present disclosure, however, these requantization operations may be eliminated by absorbing the quantization parameters of the input tensors 105 into the convolution operation 115, as discussed in more detail below.

Although the illustrated example depicts a convolution operation 115, in aspects, the depicted concatenation-convolution sequence may implement a variety of operations, including convolution, matrix multiplication, fully connected layer operations, and the like. That is, matrix multiplication and fully connected operations may be implemented using convolution, in some aspects. In some aspects, the convolution operation 115 may additionally or alternatively correspond to other multiplicative and/or additive tensor operations. In this way, aspects of the present disclosure can be used to eliminate requantization operations when concatenation is used to generate input to a variety of operations, including convolution operations, matrix multiplications, and/or fully connected layers.

In some aspects, the illustrated workflow 100 may correspond to a portion of a machine learning architecture (e.g., a neural network) with any number of operations or layers performed prior to and/or subsequent to the workflow 100. That is, the input tensors 105 may be initial input(s) to the model (e.g., where the convolution operation is used in the first layer of the model), or may be intermediate tensors (e.g., activation tensors) generated by a prior layer of the model. Similarly, the output tensor 120 may be used as the input to a subsequent layer, or may be used as the output of the model itself (if the workflow 100 is used in the final layer, such as when the convolution operation 115 implements a fully connected layer).

In some aspects, each input tensor 105A-N may be quantized using a respective set of quantization parameters. That is, the input tensor 105A may be quantized according to a first set of quantization parameters (e.g., a first scale and a first zero point), the input tensor 105B may be quantized according to a second set of quantization parameters (e.g., a second scale and a second zero point), and the input tensor 105N may be quantized according to a third set of quantization parameters (e.g., a third scale and a third zero point). The second set of quantization parameters may be different from the first set of quantization parameters, and the third set of quantization parameters may be different from both the first and second sets of quantization parameters. Generally, the quantization parameters used for each input tensor 105 may be determined or generated during training and/or after training (e.g., based on data collected during training and/or based on test data subsequent to training, such as based on the average, minimum, and/or maximum values seen for each tensor during training and/or during testing). That is, the scale parameter and zero point parameter used to quantize each input tensor 105 may be determined/defined prior to the optimizations described herein are applied. In at least some conventional approaches, the quantized input tensors 105 are each requantized according to a shared set of quantization parameters, and then concatenated by the concatenation operation 110.

In some aspects, the parameters of the convolution operation 115 (e.g., weights and/or biases) may also be quantized (e.g., during or after training). That is, the parameters of the convolution operation 115 may themselves be quantized according to a corresponding set of quantization parameters, including a scale value and/or zero point value.

In some aspects, as discussed in more detail below, the (quantized) parameters of the convolution operation 115 can be modified or updated to account for the quantization parameters of the input tensors 105. This allows the workflow 100 to be performed during inferencing without performing any separate requantization operations on the input tensors 105, substantially reducing the computational expense of inference as compared to at least some conventional architectures.

### Example Workflow for Modified Concatenation-Convolution Operations in Machine Learning Models

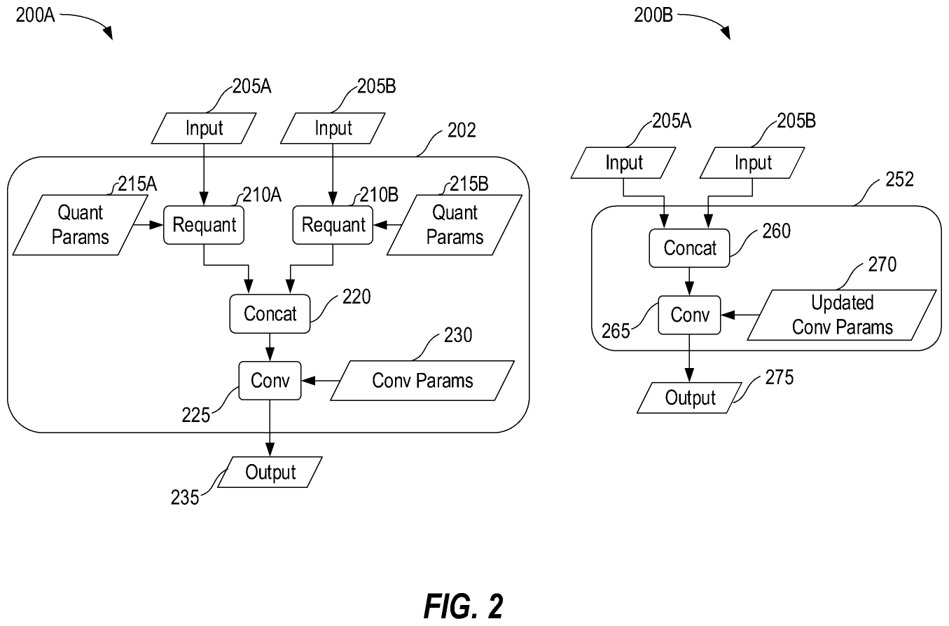

FIG. 2 depicts example workflows 200A and 200B for modified concatenation-convolution operations in machine learning model architectures. Specifically, the workflow 200A (including block 202) corresponds to a concatenation-convolution operation without optimization (e.g., using requantization operations), and the workflow 200B (including block 252) corresponds to an optimized or modified concatenation-convolution operation that does not use requantization operations. In some aspects, the blocks 202 and/or 252 correspond to the combination of the concatenation operation 110 and convolution operation 115, each of FIG. 1. In some aspects, the block 202 may correspond to an initial concatenation-convolution operation (e.g., prior to optimization), while the block 252 depicts a modified or optimized concatenation-convolution operation (which eliminates requantization operations).

As illustrated, block 202 receives two input tensors 205A and 205B (collectively referred to herein as “input tensors 205”) as input. As discussed above, these input tensors 205 may be requantized according to corresponding quantization parameters. For example, the input tensor 205A may be associated with quantization parameters 215A which were used to quantize the input tensor 205A (e.g., during a prior layer or component of a machine learning model), and which are similarly used to requantize the input tensor 205A at requantization operation 210A to a set of shared quantization parameters). Similarly, the input tensor 205B may be associated with the quantization parameters 215B, which were used to quantize the input tensor 205B and which are also used at requantization operation 210B to requantize the input tensor 205B to the shared quantization parameters. In the illustrated concatenation-convolution sequence, the input tensor 205A is requantized using a first requantization operation 210A based on the quantization parameters 215A for the input tensor 205A, while the input tensor 205B is requantized using a second requantization operation 210B based on the quantization parameters 215B for the input tensor 205B. For example, as discussed above, each requantization operation 210A, 210B may use Equation 1 above to requantize the input tensors 205 to a shared quantization scheme to generate requantized tensors that have a shared or common set of quantization parameters.

These requantized tensors are then provided as input to the concatenation operation 220, which concatenates the tensors together. The concatenated tensor is then provided as input to the convolution operation 225. As illustrated, the convolution operation 225 uses a (potentially quantized) set of convolution parameters 230 to generate output tensor 235 based on the concatenated requantized tensors. For example, the convolution operation 225 may convolve or multiply the concatenated tensor with one or more weights specified in the convolution parameters 230, add a bias term specified in the convolution parameters 230, and the like.

In the illustrated workflow 200B, the block 252 does not rely on or use requantization operations (e.g., requantization operations 210 included in block 202), and the concatenation operation 260 is performed directly on the quantized input tensors 205A and 205B (as compared to the concatenation operation 220 of block 202, which concatenates requantized tensors). That is, if input tensors 205A and 205B are represented as A and B, respectively, the output of the concatenation operation 220 is [A*, B*] (e.g., requantized tensors A* and B* concatenated together), while the output of the concatenation operation 220 is [A, B]. Further, as illustrated, the updated convolution parameters 270 may generally correspond to a modified or updated version of the convolution parameters 230 of block 202 (e.g., modified to absorb the quantization parameters of the input tensors 205A-B, as discussed below in more detail).

In some aspects, the weights of the convolution operation 225 may be defined as W=[W_{A}, W_{B}], where W is the total set of weights (e.g., in floating point format, such as float32), W_{A} is a first subset of the weights, the first subset of weights corresponding to the first input tensor 205A (e.g., the weights that correspond to the channels of input tensor 205A), and W_{B} is a subset of the weights that corresponds to the input tensor 205B. In some aspects, therefore, the weights of the convolution operation 225 may be quantized according to Equation 2 below, where W is the weights, W_{q_A} and W_{q_B} are the quantized first and second subsets of the weights (e.g., quantized W_{A} and W_{B}, respectively), S_{W} is the quantization scale for the weights, and Z_{W} is the quantization zero point:

$$W = [ {S}_{W} ( {W}_{q \_ A} - {Z}_{W} ) , {S}_{W} ( {W}_{q \_ B} - {Z}_{W} ) ] \qquad ( 2 )$$

In some aspects, therefore, the output of the convolution operation 225 (e.g., the output tensor 235) may be defined using Equation 3 below, where Out is the element-wise output of the convolution operation 225 (e.g., in floating point format, such as float32), n is the number of values in the input tensor 205A (e.g., for a first input corresponding to the element-wise output), W_{q_Ai} is the i-th weight of the subset of weights W_{A} that corresponds to the input tensor 205A, Aᵢ is the i-th value of the input tensor 205A, S_{A} is the scale of the input tensor 205A, Z_{A} is the zero point of the input tensor 205A, m is the number of values in the input tensor 205B (e.g., for a second input corresponding to the element-wise output), W_{q_Bj} is the j-th weight of the subset of weights Wp that corresponds to the input tensor 205B, B; is the j-th value of the input tensor 205B, S_{B} is the scale of the input tensor 205B, Z_{B} is the zero point of the input tensor 205B, and bias is a bias term for the element-wise output:

$$Out = {\sum }_{i}^{n} {S}_{W} ( {W}_{{q}_{A i}} - {Z}_{W} ) {S}_{A} ( {A}_{i} - {Z}_{A} ) + {\sum }_{j}^{m} {S}_{W} ( {W}_{q \_ Bj} - {Z}_{W} ) {S}_{B} ( {B}_{j} - {Z}_{B} ) + bias \qquad ( 3 )$$

In some aspects, Equation 3 may be rewritten using Equation 4 below, where

$${\tilde{W}}_{A i} = {S}_{W} ( {W}_{q \_ Ai} - {Z}_{W} ) {S}_{A} and {\tilde{W}}_{B j} = {S}_{W} ( {W}_{q \_ Bi} - {Z}_{W} ) {S}_{B} : Out = {\sum }_{i}^{n} {\tilde{W}}_{A i} ( {A}_{i} - {Z}_{A} ) + {\sum }_{j}^{m} {\tilde{W}}_{B j} ( {B}_{j} - {Z}_{B} ) + bias \qquad ( 4 )$$

In some aspects, \tilde{W}_{Ai} and \tilde{W}_{Bj} can be precomputed, as each depends only on values that are known prior to inferencing. That is, because \tilde{W}_{Ai} and \tilde{W}_{Bj} are defined based on the initial weight values, the quantization parameters of the initial weights, and the quantization scales of the input tensors, \tilde{W}_{Ai} and \tilde{W}_{Bj} can be computed offline, prior to inferencing, and stored for subsequent recall. During inferencing, the remaining terms can be computed based on the values of the input tensors 205 to generate the output.

Therefore, in some aspects, updated or modified convolution weights may be defined as \tilde{W}=[\tilde{W}_{A}, \tilde{W}_{B}], where \tilde{W} is the modified convolution weights, \tilde{W}_{A} is a subset of the modified weights that corresponds to the input tensor 205A, and \tilde{W}_{B} is a subset of the modified weights that corresponds to the input tensor 205B.

In this way, in some aspects, modified convolution weights that absorb or account for the differing quantization parameters of the input tensors 205 may be generated offline using Equation 5 below:

$$\tilde{W} = [ {S}_{W} ( {W}_{q \_ A} - {Z}_{W} ) {S}_{A} , {S}_{W} ( {W}_{q \_ B} - {Z}_{W} ) {S}_{B} ] \qquad ( 5 )$$

In some aspects, once the modified weights have been generated, the bias of the convolution operation 225 may similarly be modified or updated. For example, updated quantization parameters (e.g., a scale S_{\tilde{W}} and zero point Z_{\tilde{W}}) for the updated or modified weights \tilde{W} may be determined to allow the modified weights to be quantized to generate \tilde{W}_{q}. The modified or updated bias term can then be defined using Equation 6 below, where [symbol] is the modified bias parameter, [o] indicates the index of the output channel (e.g., where bias is computed/updated independently for each output channel), and bias is the initial bias of the initial convolution operation 225:

$$\text{?} [ o ] = {S}_{\tilde{W}} ( \frac{bias [ o ]}{{S}_{\tilde{W}}} - {Z}_{A} * {\sum }_{i}^{n} ( {\tilde{W}}_{{q}_{\_ Ai}} [ o ] - {Z}_{\tilde{W}} ) - {Z}_{B} * {\sum }_{j}^{m} ( {\tilde{W}}_{q \_ Bj} [ o ] - {Z}_{\tilde{W}} ) ) \qquad ( 6 )$$

In some aspects, this modified/updated bias may itself be quantized as well.

In this way, using the modified convolution parameters (e.g., updated weights \tilde{W} and updated bias [symbol] ), block 252 allows input tensors to be directly concatenated without requantizing. Specifically, as illustrated, quantized input tensors 205A and 205B may be provided directly to the concatenation operation 260, without first being requantized. The concatenated tensors are then provided to the convolution operation 265, which uses the modified convolution parameters (\tilde{W} and [symbol] ) to generate convolution output 275.

In some aspects, because the modified convolution parameters can be generated offline, modification systems can thereby evaluate machine learning architectures/models to replace conventional concatenation-convolution sequences (such as block 202) with modified concatenation-convolution sequences (such as block 252). Once so modified, the modified models can be used for inferencing with substantially reduced computational expense (e.g., reduced time, reduced memory usage, reduced power consumption, and the like) while maintaining or improving model accuracy.

### Example Environment for Modifying Machine Learning Architectures to Reduce Requantization Operations

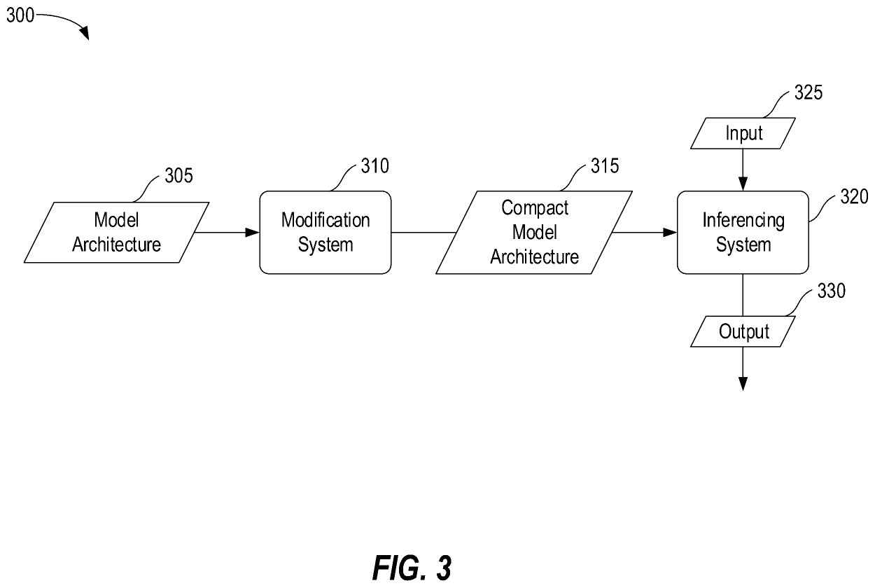

FIG. 3 depicts an example environment 300 for modifying machine learning model architectures to reduce requantization operations. In some aspects, the components depicted in the environment 300 can implement some or all of the workflows and architectures discussed above.

In the illustrated example, a modification system 310 accesses a model architecture 305, and generates a corresponding compact model architecture 315. This compact model architecture 315 is accessed by an inferencing system 320, which processes input 325 using the compact model architecture 315 to generate corresponding output 330.

Although the modification system 310 and inferencing system 320 are depicted as discrete components for conceptual clarity, in some aspects, the operations of the modification system 310 and inferencing system 320 may be performed by a single system. For example, the inferencing system may access the initial model architecture 305, and generate and use the compact model architecture 315. Further, although not depicted in the illustrated example, in some aspects, the modification system 310 corresponds to the training system that generated or trained the initial model architecture 305. That is, a single system may train the model architecture 305 and modify this architecture to generate compact model architecture 315. In some aspects, although not depicted in the illustrated example, the inferencing system 320 may be part of a different environment than that of the modification system 310.

In the illustrated example, the modification system 310 accesses the model architecture 305 from one or more sources (which may include remote sources such as a training system, as well as local sources, such as when the modification system 310 is the training system). As used herein, accessing data (such as model architecture 305) can generally include receiving, requesting, retrieving, obtaining, or otherwise gaining access to the data.

In some aspects, the model architecture 305 corresponds to a trained machine learning model. For example, the model architecture 305 may correspond to a neural network architecture having a set of learned parameters (e.g., weights and/or biases). In some aspects, the model architecture 305 includes one or more concatenation-convolution operations (which may include concatenation-matrix multiplication operations and/or concatenation-fully connected operations), as discussed above. For example, at one or more places in the model architecture 305, the architecture may include an operation to concatenate multiple tensors (e.g., concatenation operation 110 of FIG. 1), followed by an operation to process the concatenated data using convolution (e.g., convolution operation 115 of FIG. 1).

In the illustrated example, the modification system 310 processes the trained model architecture 305 to improve such concatenation-convolution operations, as discussed above. For example, for each such concatenation operation the modification system 310 may ingest or absorb the quantization parameters of the inputs into the convolution itself (e.g., to replace block 202 of FIG. 2 with block 252 of FIG. 2). In doing so, the modification system 310 can eliminate the requantization operations (e.g., requantization operations 210 of FIG. 2) that are used in the initial model architecture 305 and/or in at least some conventional systems.

In the illustrated example, the compact model architecture 315 (also referred to in some aspects as the updated model architecture, modified model architecture, optimized model architecture, and the like) generally corresponds to the initial model architecture 305, but with one or more requantization operations (which were used as part of one or more concatenation operations in the initial architecture) removed. For example, for each instance of a concatenation-convolution operation that included requantization (e.g., for each instance of block 202 of FIG. 2), the modification system 310 may absorb the quantization parameters of the inputs (e.g., using Equation 5 and/or Equation 6, above) into the convolution operation, and replace the initial concatenation-convolution sequence with a modified version (e.g., with an instance of block 252 of FIG. 2) that does not include requantization operations.

As illustrated, the inferencing system 320 can then use the compact model architecture 315 to performing runtime inferencing. That is, the inferencing system 320 can access input 325, and process the input using the compact model architecture 315 to generate output 330. As discussed above, the inferencing system 320 can generally process input 325 using the compact model architecture 315 with substantially reduced computational resources and latency, as compared to processing input using the initial model architecture 305. Additionally, the output 330 is generally at least as accurate as the output of the model architecture 305 would be, were the model architecture 305 used instead of using the modified architecture. In some cases, the compact model architecture 315 can produce more accurate output, as compared to the initial architecture (e.g., because the requantization operations in the initial architecture can affect data precision).

Although the illustrated example depicts the inferencing system 320 accessing the input 325 from an external source and/or providing the output 330 to an external source for conceptual clarity, in aspects, the input may be accessed from any source, and the output may be provided to any system and/or used for any operations, depending on the particular implementation.

### Example Method for Generating Updated Model Architectures to Eliminate Requantization Operations

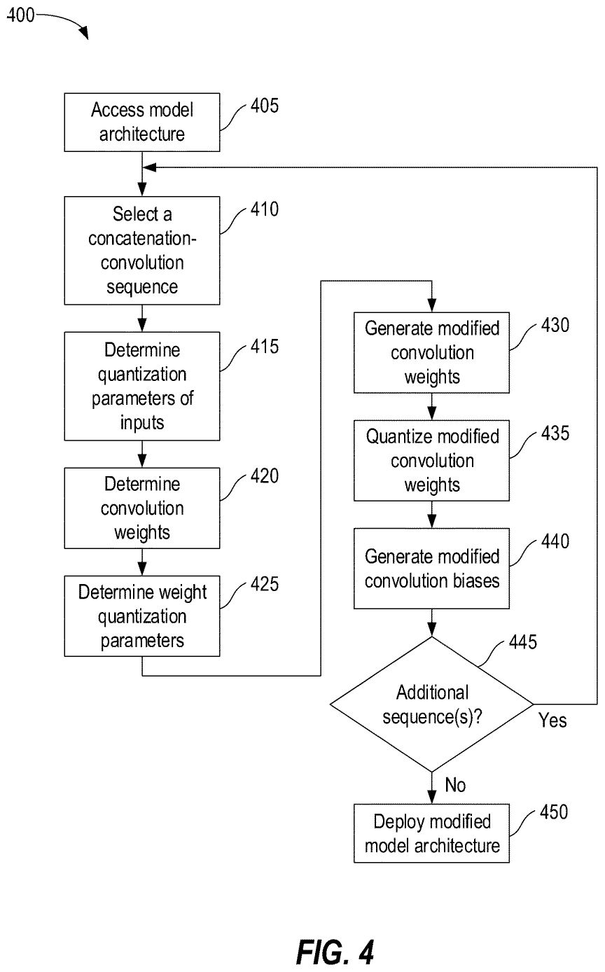

FIG. 4 is a flow diagram depicting an example method 400 for generating updated model architectures to eliminate requantization operations. In some aspects, the method 400 is performed by a modification system, such as the modification system 310 of FIG. 3. In some aspects, as discussed above, the modification system may operate as a component of a training system (e.g., as a component of the system that trains the initial machine learning model) and/or as a component of an inferencing system (e.g., as a component of the system that uses the modified machine learning model to generate inferences during runtime).

At block 405, the modification system accesses a model architecture (such as the model architecture 305 of FIG. 3). Generally, the model architecture corresponds to a trained machine learning model (e.g., a model/architecture with parameters, such as weights and/or biases, having values that were learned during training). As discussed above, accessing the model architecture may include accessing this architecture from a separate training system (e.g., where the model is trained on one system and deployed or provided to the modification system), and/or training the model locally (e.g., where the modification system trains the model, or refines a pre-trained model, locally).

At block 410, the modification system selects a concatenation-convolution sequence in the initial model architecture. For example, the modification system may identify any concatenation operations that generate (concatenated) input for a convolution operation. In some aspects, the modification system can similarly identify any concatenation operations that generate input for matrix multiplication operations and/or fully connected layers, as discussed above. As discussed above, such concatenation-convolution sequences can be modified to eliminate requantization operations using aspects of the present disclosure. Generally, the modification system may select the concatenation-convolution operation using any suitable techniques, including randomly or pseudo-randomly.

At block 415, the modification system determines the quantization parameters for the inputs to the concatenation operation. For example, for each respective input to the concatenation operation (e.g., input tensors 105 of FIG. 1 and/or input tensors 205 of FIG. 2), the modification system can determine a respective set of quantization parameters, such as a quantization scale(S) and quantization zero point (Z).

At block 420, the modification system can determine the convolution weights of the selected concatenation-convolution sequence (e.g., the weight value(s) that were learned during training). In some aspects, these determined weights may be referred to as an initial set of convolution weights and/or an initial set of convolution parameters. At block 425, the modification system similarly determines the quantization parameters of the initial weights. For example, for weights W, the modification system may determine the quantization scale S_{W} and zero point Z_{W}.

At block 430, the modification system generates updated or modified convolution weights for the concatenation-convolution operation. In some aspects, these modified weights are referred to as a modified set of convolution weights and/or a modified set of convolution parameters. For example, the modification system may generate the modified weights based on the initial weights of the convolution and the quantization parameters of the initial weights (e.g., determined at block 420), some or all of the quantization parameters for the input tensors (e.g., the quantization scales for the input tensors), and the like. In some aspects, the modification system uses Equation 5, discussed above, to generate the updated or modified convolution weights.

At block 435, the modification system can quantize the modified convolution weights. In some aspects, quantizing the modified weights includes determining quantization parameters for the modified weights (e.g., a new quantization scale and/or zero point).

At block 440, the modification system can generate updated or modified convolution bias(es) for the modified convolution operation based on the modified weights. In some aspects, the modified bias is determined based further on the initial or original bias of the convolution operation, the quantization parameters of the modified weights, and/or some or all of the quantization parameters for the input tensors (e.g., the zero points of the input tensors). In some aspects, the modification system uses Equation 6, discussed above, to generate the updated or modified convolution bias(es).

At block 445, the modification system determines whether there is at least one additional concatenation-quantization sequence in the initial model architecture. That is, the modification system can determine whether there is at least one more instance of a concatenation operation (with accompanying requantization operations), in the initial architecture, that has not been processed by absorbing the quantization parameters into the convolution operation to eliminate the requantization(s). If so, then the method 400 returns to block 410.

If, at block 445, the modification system determines that no additional concatenation-convolution sequences remain, then the method 400 continues to block 450. At block 450, the modification system deploys the updated or modified machine learning model architecture. Generally, deploying the modified architecture can include any number of operations to provide the modified architecture for inferencing. For example, the modification system may deploy the modified architecture locally, and/or provide the modified architecture to an inferencing system for runtime use.

In this way, the modification system can modify machine learning models to eliminate or reduce requantization operations, thereby substantially reducing the computational expense of using the model for inferencing (e.g., reducing the memory usage, latency, power consumption, and the like). In some aspects, the modified architectures can enable these improved efficiencies and reduced expense while also yielding similar or improved model accuracy, as discussed above.

Example Method for Using Updated Model Architectures without Requantization Operations

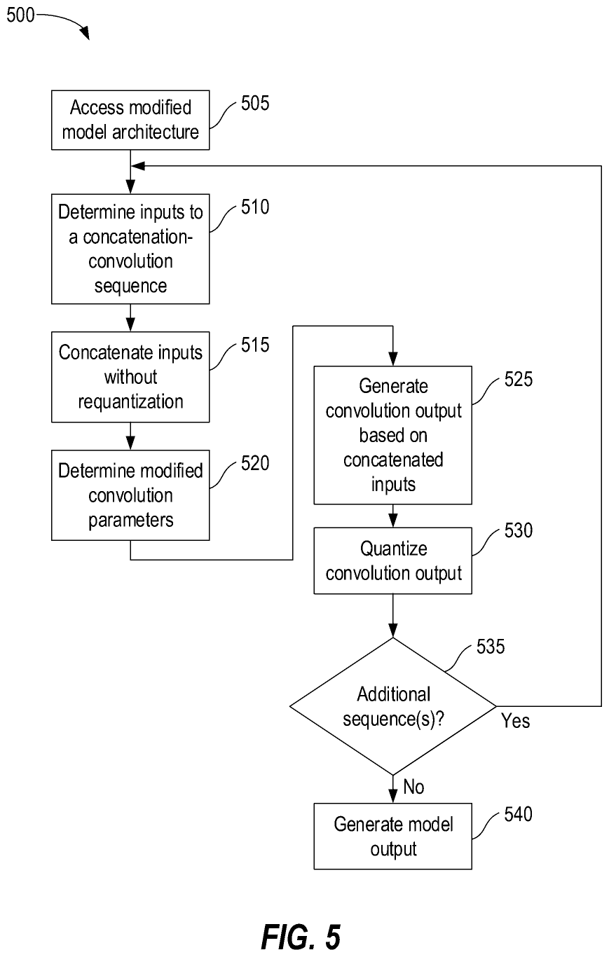

FIG. 5 is a flow diagram depicting an example method 500 for using updated model architectures without requantization operations. In some aspects, the method 500 is performed by an inferencing system, such as the inferencing system 320 of FIG. 3.

At block 505, the inferencing system accesses a modified or improved machine learning model architecture (such as the compact model architecture 315 of FIG. 3). Generally, the modified model architecture corresponds to a trained machine learning model (e.g., a model/architecture with parameters, such as weights and/or biases, having values that were learned during training) that has been modified to eliminate requantization operations (e.g., by absorbing quantization parameters into the convolution operation(s). In some aspects, the inferencing system accesses the modified architecture from a discrete or remote system (e.g., from a training system or a modification system). In some aspects, the inferencing system accesses the modified architecture from a local source (e.g., if the inferencing system modifies the initial architecture locally to create the modified architecture).

At block 510, the inferencing system determines or generates inputs to a concatenation-convolution sequence in the modified model architecture. Generally, determining the concatenation inputs can include performance of a variety of operations, depending on the particular implementation and where, in the modified model, the concatenation-convolution sequence is used. For example, if the concatenation-convolution operation is included in the first layer of the model, then determining the inputs can include receiving, obtaining, or otherwise determining input tensors to the model. If the concatenation-convolution operation is used in an internal layer, then determining the inputs can include generating these inputs (e.g., generating activation tensors) in a prior layer.

At block 515, the inferencing system concatenates the determined inputs without performing requantization on the inputs. That is, rather than first requantizing the inputs to a shared set of quantization parameters prior to concatenating the (requantized) tensors, the inferencing system can instead directly concatenate the tensors, as discussed above.

At block 520, the inferencing system determines a set of modified convolution parameters for the concatenation-convolution sequence. For example, as discussed above, the inferencing system can determine the modified weights and/or biases of the modified convolution operation (e.g., by reading indications of the modified weights and/or biases from memory).

At block 525, the inferencing system can generate convolution output based on the concatenated inputs. For example, the inferencing system may convolve (e.g., multiply) the concatenated inputs with the determined modified convolution parameters (e.g., the weights).

At block 530, the inferencing system can optionally quantize the convolution output. For example, if the concatenation-convolution sequence is used in an internal layer (e.g., the convolution output is not the final output of the model), then the inferencing system may quantize the convolution output such that this output can be provided as input to a subsequent layer.

At block 535, the inferencing system determines whether there is at least one additional concatenation-convolution sequence remaining in the modified architecture. If so, then the method 500 returns to block 510. Although the illustrated example depicts determining whether there is at least one additional concatenation-convolution sequence remaining, in some aspects, the inferencing system may additionally or alternatively determine whether any other operations remain (e.g., convolution layers without such concatenation). If so, then the inferencing system may perform these subsequent operations according to the modified architecture, until all operations in the model have been completed and/or until another concatenation-convolution sequence is reached.

If no additional operations remain, the method 500 continues to block 540, where the inferencing system generates/outputs model output for the modified architecture. Generally, the operations used to generate this model output may vary depending on the particular implementation/architecture.

In this way, the inferencing system can use modified machine learning models that eliminate or reduce requantization operations, thereby substantially reducing the computational expense of using the model for inferencing (e.g., reducing the memory usage, latency, power consumption, and the like). In some aspects, the modified architectures can enable these improved efficiencies and reduced expense while also yielding similar or improved model accuracy, as discussed above.

Example Method for Generating Convolution Output without Requantization

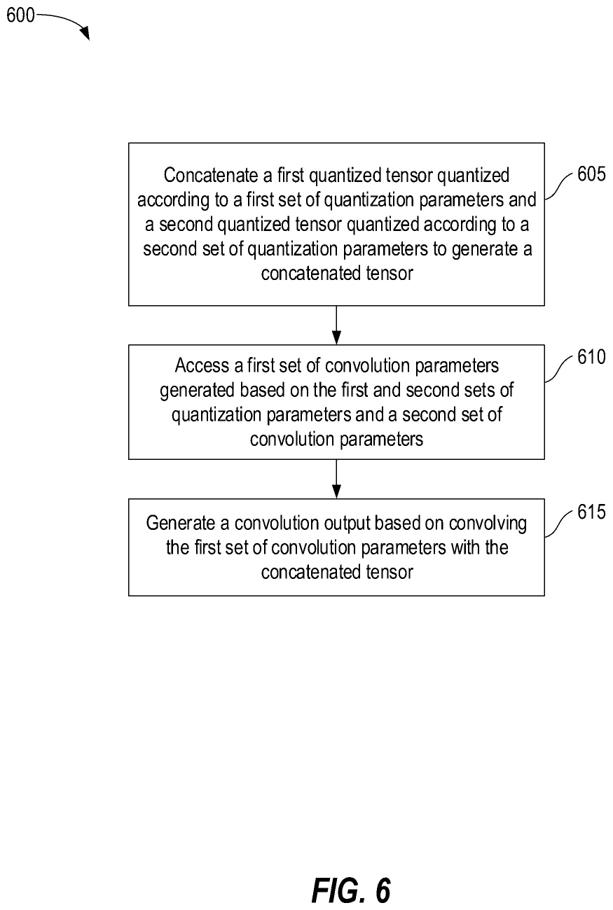

FIG. 6 is a flow diagram depicting an example method 600 for generating convolution output without requantization. In some aspects, the method 600 is performed by an inferencing system, such as the inferencing system 320 of FIG. 3.

At block 605, a first quantized tensor quantized according to a first set of quantization parameters and a second quantized tensor quantized according to a second set of quantization parameters are concatenated to generate a concatenated tensor. This concatenation may be performed without requantizing the first or second quantized tensor.

At block 610, a first set of convolution parameters (e.g., a modified set of convolution parameters) generated for at least one layer of a first machine learning model based on the first and second sets of quantization parameters and a second set of convolution parameters (e.g., an initial set of convolution parameters) for at least one layer of a second machine learning model is accessed.

At block 615, a convolution output is generated for the at least one layer of the first machine learning model based on convolving the first set of convolution parameters with the concatenated tensor.

In some aspects, the method 600 further includes quantizing the convolution output.

In some aspects, the convolution output corresponds to at least one of a matrix multiplication output or a fully connected layer output.

In some aspects, the first set of quantization parameters comprises a first quantization scale and a first zero point, and the second set of quantization parameters comprises a second quantization scale and a second zero point.

In some aspects, the second set of convolution parameters were quantized according to a third quantization scale and a third zero point, and the first set of convolution parameters were generated based on: the first, second, and third quantization scales, and the third zero point.

In some aspects, the first set of convolution parameters were generated according to \tilde{W}=[S_{W}(W_{q_A}−Z_{W}) S_{A}, S_{W}(W_{q_B}−Z_{W}) S_{B}], wherein: \tilde{W} is the first set of convolution parameters, S_{W} is the third quantization scale, W_{q_A} is a first subset of the second set of convolution parameters corresponding to the first quantized tensor, Z_{W} is the third zero point, S_{A} is the first quantization scale, W_{q_B} is a second subset of the second set of convolution parameters corresponding to the second quantized tensor, and S_{B} is the second quantization scale.

In some aspects, the first set of convolution parameters were quantized based on a first quantization scale and a first zero point, and the first set of convolution parameters comprise a first bias generated based on a second bias of the second set of convolution parameters, the first quantization scale, and the first zero point.

In some aspects, the first bias was generated according to

$$\text{?} [ o ] = {S}_{\tilde{W}} ( \frac{bias [ o ]}{{S}_{\tilde{W}}} - {Z}_{A} * {\sum }_{i}^{n} ( {\tilde{W}}_{qAi} [ o ] - {Z}_{\tilde{W}} ) - {Z}_{B} * {\sum }_{j}^{m} ( {\tilde{W}}_{q \_ Bj} [ o ] - {Z}_{\tilde{W}} ) ) ,$$

where: [symbol] bras is the first bias, bias is the second bias, S_{\tilde{W}} is the first quantization scale, Z_{A} is a zero point of the first quantized tensor, \tilde{W}_{q_A} is a first subset of the quantized first set of convolution parameters corresponding to the first quantized tensor, Z_{\tilde{W}} is the first zero point, Z_{B} is a zero point of the second quantized tensor, and \tilde{W}_{q_A} is a second subset of the quantized first set of convolution parameters corresponding to the second quantized tensor.

### Example Method for Modifying Model Architectures to Eliminate Requantization

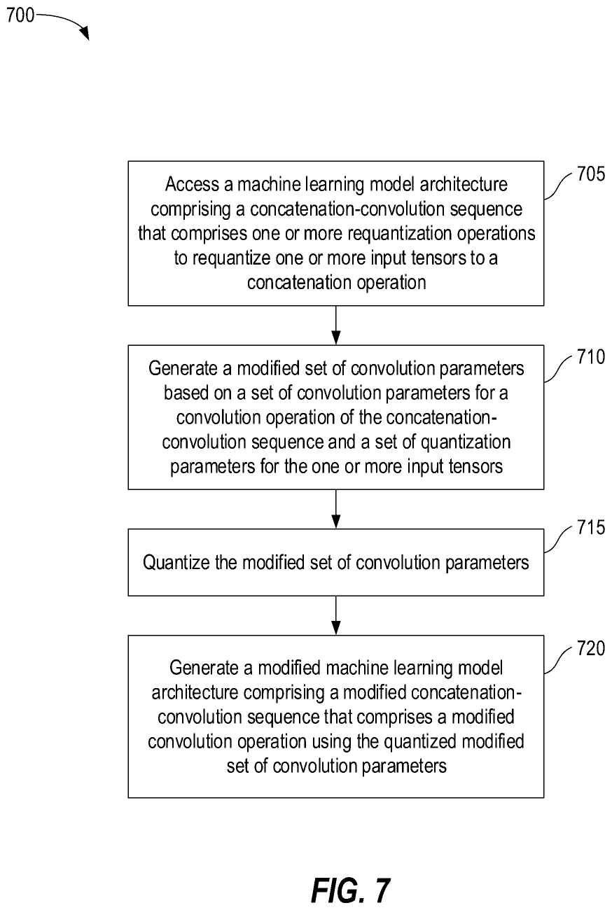

FIG. 7 is a flow diagram depicting an example method 700 for modifying model architectures to eliminate requantization. In some aspects, the method 700 is performed by a modification system, such as the modification system 310 of FIG. 3.

At block 705, a machine learning model architecture comprising a concatenation-convolution sequence that comprises one or more requantization operations to requantize one or more input tensors to a concatenation operation is accessed.

At block 710, a modified set of convolution parameters is generated based on a set of convolution parameters for a convolution operation of the concatenation-convolution sequence and a set of quantization parameters for the one or more input tensors.

At block 715, the modified set of convolution parameters is quantized.

At block 720, generating a modified machine learning model architecture comprising a modified concatenation-convolution sequence that comprises a modified convolution operation using the quantized modified set of convolution parameters.

In some aspects, during inferencing, a first tensor and a second tensor are processed using the modified concatenation-convolution sequence by: concatenating the first tensor and the second tensor without requantizing either the first tensor or the second tensor before the concatenating, and generating a convolution output by processing the concatenated first tensor and second tensor using the modified convolution operation.

In some aspects, the first tensor is quantized according to a first set of quantization parameters, and the second tensor is quantized according to a second set of quantization parameters.

In some aspects, the concatenation-convolution sequence implements at least one of a matrix multiplication operation or a fully connected layer operation.

In some aspects, the set of convolution parameters are quantized according to a first quantization scale and a first zero point, and the set of quantization parameters for the one or more input tensors comprises: a second quantization scale of a first subset of the set of convolution parameters corresponding to a first tensor of the one or more input tensors, and a third quantization scale of a second subset of the set of convolution parameters corresponding to a second tensor of the one or more input tensors.

In some aspects, the modified set of convolution parameters is generated according to \tilde{W}=[S_{W}(W_{q_A}−Z_{W}) S_{A}, S_{W} (W_{q_B}−Z_{W})S_{B}], wherein: \tilde{W} is the modified set of convolution parameters, S_{W} is the first quantization scale, W_{q_A} is the first subset of the set of convolution parameters, Z_{W} is the first zero point, S_{A} is the second quantization scale, W_{q_B} is the second subset of the set of convolution parameters, and S_{B} is the third quantization scale.

In some aspects, the method 700 further includes generating a modified bias for the modified convolution operation based on a bias of the convolution operation, a quantization scale of the modified set of convolution parameters, and a zero point of the modified set of convolution parameters.

In some aspects, the modified bias is generated according to

$$\text{?} [ o ] = {S}_{\tilde{W}} ( \frac{bias [ o ]}{{S}_{\tilde{W}}} - {Z}_{A} * {\sum }_{i}^{n} ( {\tilde{W}}_{{q}_{\_ Ai}} [ o ] - {Z}_{\tilde{W}} ) - {Z}_{B} * {\sum }_{j}^{m} ( {\tilde{W}}_{q \_ Bj} [ o ] - {Z}_{\tilde{W}} ) ) ,$$

wherein: [symbol] is the modified bias, [o] indicates the index of the output channels, bias is the bias of the convolution operation, S_{\tilde{W}} is the quantization scale of the modified set of convolution parameters, Z_{A} is a zero point of a first tensor of the one or more input tensors, \tilde{W}_{q_Ai} is a first subset of the quantized modified set of convolution parameters corresponding to the first tensor, Z_{\tilde{W}} is the zero point of the modified set of convolution parameters, Z_{B} is a zero point of a second tensor of the one or more input tensors, and \tilde{W}_{q_Bj} is a second subset of the quantized modified set of convolution parameters corresponding to the second tensor.

### Example Optimizer Processing System

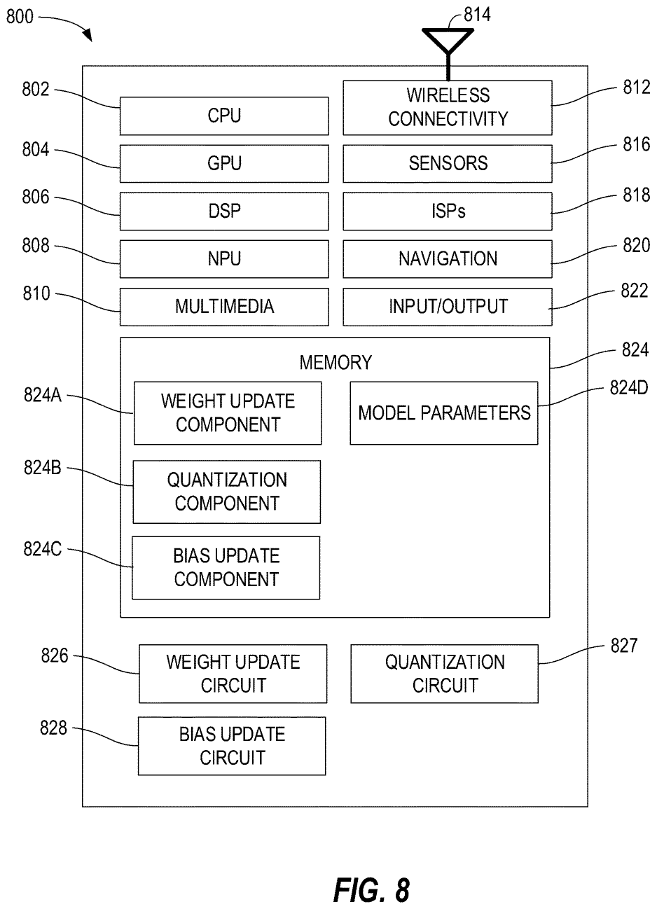

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In some aspects, the processing system 800 may correspond to a machine learning system, such as the modification system 310 of FIG. 3. Although depicted as a single system for conceptual clarity, in at least some aspects, as discussed above, the operations described below with respect to the processing system 800 may be distributed across any number of devices or systems, and may be implemented as a component of another system such as a training system or an inferencing system.

Processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of memory 824).

Processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a weight update component 824A, a quantization component 824B, and a bias update component 824C. The memory 824 also includes a set of model parameters 824D. Though depicted as discrete components for conceptual clarity in FIG. 8, the illustrated components (and others not depicted) may be collectively or individually implemented in various aspects.

The model parameters 824D may generally correspond to the initial parameters of all or a part of one or more machine learning models, such as the model architecture 305 of FIG. 3. Although not depicted in the illustrated example, in some aspects, the memory 824 can further include model parameters of one or more updated or improved architectures (e.g., compact model architecture 315 of FIG. 3)

Processing system 800 further comprises weight update circuit 826, quantization circuit 827, and bias update circuit 828. The depicted circuits, and others not depicted, may be configured to perform various aspects of the techniques described herein.

For example, weight update component 824A and weight update circuit 826 may be used to generate updated or modified weights for convolution operations based on quantization parameters of the inputs to a preceding concatenation operation (such as using Equation 5), as discussed above. Quantization component 824B and quantization circuit 827 may be used to quantize the modified weights, as discussed above. Bias update component 824C and bias update circuit 828 may be used to generate updated or modified bias parameters for convolution operations based on the modified weights (e.g., using Equation 6), as discussed above.

Though depicted as separate components and circuits for clarity in FIG. 8, weight update circuit 826, quantization circuit 827, and weight update circuit 828 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia component 810, wireless connectivity component 812, sensor processing units 816, ISPs 818, and/or navigation processor 820 may be omitted in other aspects. Further, aspects of processing system 800 maybe distributed between multiple devices.

### Example Inferencing Processing System

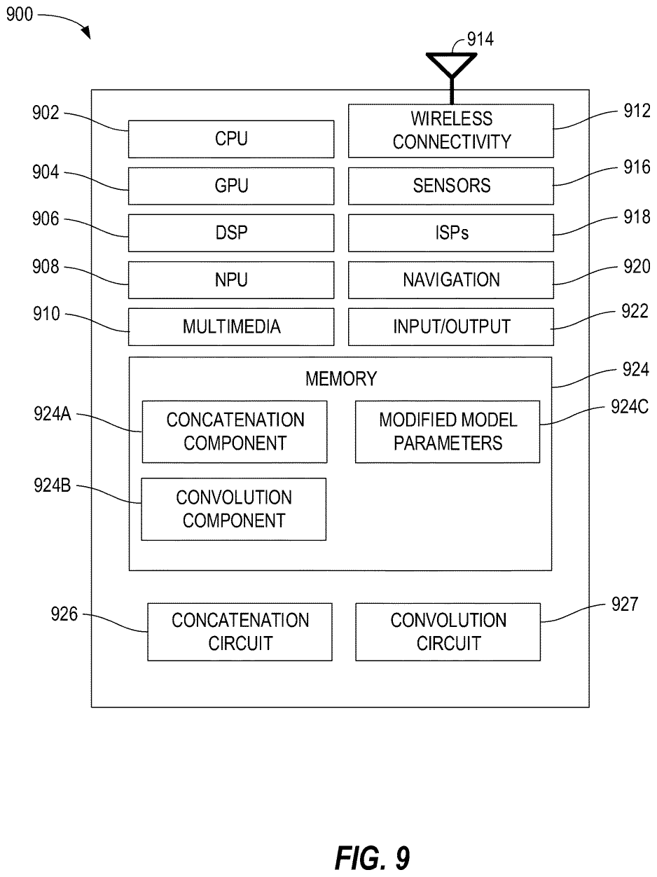

In some aspects, the workflows, techniques, and methods described with reference to FIGS. 1-7 may be implemented on one or more devices or systems. FIG. 9 depicts an example processing system 900 configured to perform various aspects of the present disclosure, including, for example, the techniques and methods described with respect to FIGS. 1-7. In some aspects, the processing system 900 may correspond to a machine learning system, such as the inferencing system 320 of FIG. 3. Although depicted as a single system for conceptual clarity, in at least some aspects, as discussed above, the operations described below with respect to the processing system 900 may be distributed across any number of devices or systems.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of memory 924).

Processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a concatenation component 924A and a convolution component 924B. The memory 924 also includes a set of modified model parameters 924C. Though depicted as discrete components for conceptual clarity in FIG. 9, the illustrated components (and others not depicted) may be collectively or individually implemented in various aspects.

The modified model parameters 924C may generally correspond to the parameters of an optimized machine learning model, such as the compact model architecture 315 of FIG. 3. Although not depicted in the illustrated example, in some aspects, the memory 924 can further include modified model parameters of the initial model architectures (e.g., model architecture 305 of FIG. 3)

Processing system 900 further comprises concatenation circuit 926 and convolution circuit 927. The depicted circuits, and others not depicted, may be configured to perform various aspects of the techniques described herein.

For example, concatenation component 924A and concatenation circuit 926 may be used to concatenate input tensors (without first requantizing them), as discussed above. Convolution component 924B and convolution circuit 927 may be used to perform convolution using the concatenated (not requantized) inputs and the modified convolution parameters, as discussed above.

Though depicted as separate components and circuits for clarity in FIG. 9, concatenation circuit 926 and convolution circuit 927 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia component 910, wireless connectivity component 912, sensor processing units 916, ISPs 918, and/or navigation processor 920 may be omitted in other aspects. Further, aspects of processing system 900 maybe distributed between multiple devices.

### Example Clauses

Implementation examples are described in the following numbered clauses:

Clause 1: A method, comprising: concatenating a first quantized tensor quantized according to a first set of quantization parameters and a second quantized tensor quantized according to a second set of quantization parameters to generate a concatenated tensor; accessing a first set of convolution parameters generated for at least one layer of a first machine learning model based on the first and second sets of quantization parameters and a second set of convolution parameters for at least one layer of a second machine learning model; and generating convolution output for the at least one layer of the first machine learning model based on convolving the first set of convolution parameters with the concatenated tensor.

Clause 2: A method according to Clause 1, further comprising quantizing the convolution output.

Clause 3: A method according to any of Clauses 1-2, wherein the convolution output corresponds to at least one of a matrix multiplication output or a fully connected layer output.

Clause 4: A method according to any of Clauses 1-3, wherein: the first set of quantization parameters comprises a first quantization scale and a first zero point, and the second set of quantization parameters comprises a second quantization scale and a second zero point.

Clause 5: A method according to any of Clauses 1-4, wherein: the second set of convolution parameters were quantized according to a third quantization scale and a third zero point, and the first set of convolution parameters were generated based on: the first, second, and third quantization scales, and the third zero point.

Clause 6: A method according to any of Clauses 1-5, wherein the first set of convolution parameters were generated according to \tilde{W}=[S_{W} (W_{q_A}−Z_{W})S_{A}, S_{W}(W_{q_B}−Z_{W})S_{B}], wherein: \tilde{W} is the first set of convolution parameters, S_{W} is the third quantization scale, W_{q_A} is a first subset of the second set of convolution parameters corresponding to the first quantized tensor, Z_{W} is the third zero point, S_{A} is the first quantization scale, W_{q_B} is a second subset of the second set of convolution parameters corresponding to the second quantized tensor, and S_{B} is the second quantization scale.

Clause 7: A method according to any of Clauses 1-6, wherein: the first set of convolution parameters were quantized based on a first quantization scale and a first zero point, and the first set of convolution parameters comprise a first bias generated based on a second bias of the second set of convolution parameters, the first quantization scale, and the first zero point.

Clause 8: A method according to any of Clauses 1-7, wherein the first bias was generated according to

$$\text{?} [ o ] = {S}_{\tilde{W}} ( \frac{bias [ o ]}{{S}_{\tilde{W}}} - {Z}_{A} * {\sum }_{i}^{n} ( {\tilde{W}}_{{q}_{\_ Ai}} [ o ] - {Z}_{\tilde{W}} ) - {Z}_{B} * {\sum }_{j}^{m} ( {\tilde{W}}_{q \_ Bj} [ o ] - {Z}_{\tilde{W}} ) ) ,$$

wherein: [symbol] is the first bias, [o] is the index of output channels, bias is the second bias, S_{\tilde{W}} is the first quantization scale, Z_{A} is a zero point of the first quantized tensor, \tilde{W}_{q_A} is a first subset of the quantized first set of convolution parameters corresponding to the first quantized tensor, Z_{\tilde{W}} is the first zero point, Z_{B} is a zero point of the second quantized tensor, and \tilde{W}_{q_B} is a second subset of the quantized first set of convolution parameters corresponding to the second quantized tensor.

Clause 9: A method, comprising: accessing a machine learning model architecture comprising a concatenation-convolution sequence that comprises one or more requantization operations to requantize one or more input tensors to a concatenation operation; generating a modified set of convolution parameters based on a set of convolution parameters for a convolution operation of the concatenation-convolution sequence and a set of quantization parameters for the one or more input tensors; quantizing the modified set of convolution parameters; and generating a modified machine learning model architecture comprising a modified concatenation-convolution sequence that comprises a modified convolution operation using the quantized modified set of convolution parameters.

Clause 10: A method according to Clause 9, wherein during inferencing, a first tensor and a second tensor are processed using the modified concatenation-convolution sequence by: concatenating the first tensor and the second tensor without requantizing either the first tensor or the second tensor before the concatenating, and generating a convolution output by processing the concatenated first tensor and second tensor using the modified convolution operation.

Clause 11: A method according to any of Clauses 9-10, wherein the first tensor is quantized according to a first set of quantization parameters, and the second tensor is quantized according to a second set of quantization parameters.

Clause 12: A method according to any of Clauses 9-11, wherein the concatenation-convolution sequence implements at least one of a matrix multiplication operation or a fully connected layer operation.

Clause 13: A method according to any of Clauses 9-12, wherein the set of convolution parameters are quantized according to a first quantization scale and a first zero point, and the set of quantization parameters for the one or more input tensors comprises: a second quantization scale of a first subset of the set of convolution parameters corresponding to a first tensor of the one or more input tensors, and a third quantization scale of a second subset of the set of convolution parameters corresponding to a second tensor of the one or more input tensors.

Clause 14: A method according to any of Clauses 9-13, wherein the modified set of convolution parameters is generated according to \tilde{W}=[S_{W}(W_{q_A}−Z_{W})S_{A}, S_{W}(W_{q_B}−Z_{W})S_{B}], wherein: \tilde{W} is the modified set of convolution parameters, S_{W} is the first quantization scale, W_{q_A} is the first subset of the set of convolution parameters, Z_{W} is the first zero point, S_{A} is the second quantization scale, W_{q_B} is the second subset of the set of convolution parameters, and S_{B} is the third quantization scale.

Clause 15: A method according to any of Clauses 9-14, further comprising generating a modified bias for the modified convolution operation based on a bias of the convolution operation, a quantization scale of the modified set of convolution parameters, and a zero point of the modified set of convolution parameters.

Clause 16: A method according to any of Clauses 9-15, wherein the modified bias is generated according to

$$\text{?} [ o ] = {S}_{\tilde{W}} ( \frac{bias [ o ]}{{S}_{\tilde{W}}} - {Z}_{A} * {\sum }_{i}^{η} ( {\tilde{W}}_{{q}_{\_ Ai}} [ o ] - {Z}_{\tilde{W}} ) - {Z}_{B} * {\sum }_{j}^{m} ( {\tilde{W}}_{q \_ Bj} [ o ] - {Z}_{\tilde{W}} ) )$$

wherein: [symbol] is the modified bias, [o] is the output channel index, bias is the bias of the convolution operation, S_{\tilde{W}} is the quantization scale of the modified set of convolution parameters, Z_{A} is a zero point of a first tensor of the one or more input tensors, \tilde{W}_{q_A} is a first subset of the quantized modified set of convolution parameters corresponding to the first tensor, Z_{\tilde{W}} is the zero point of the modified set of convolution parameters, Z_{B} is a zero point of a second tensor of the one or more input tensors, and \tilde{W}_{q_B} is a second subset of the quantized modified set of convolution parameters corresponding to the second tensor.

Clause 17: A processing system, comprising: a memory comprising computer-executable instructions; and one or more processors configured to execute the computer-executable instructions and cause the processing system to perform a method in accordance with any of Clauses 1-16.

Clause 18: A processing system, comprising means for performing a method in accordance with any of Clauses 1-16.

Clause 19: A non-transitory computer-readable medium comprising computer-executable instructions that, when executed by one or more processors of a processing system, cause the processing system to perform a method in accordance with any of Clauses 1-16.

Clause 20: A computer program product embodied on a computer-readable storage medium comprising code for performing a method in accordance with any of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method, comprising:
concatenating a first quantized tensor quantized according to a first set of quantization parameters and a second quantized tensor quantized according to a second set of quantization parameters to generate a concatenated tensor;
accessing a first set of convolution parameters generated for at least one layer of a first machine learning model based on the first and second sets of quantization parameters and a second set of convolution parameters for at least one layer of a second machine learning model; and
generating a convolution output for the at least one layer of the first machine learning model based on convolving the first set of convolution parameters with the concatenated tensor.

2. The method of claim 1, further comprising quantizing the convolution output.

3. The method of claim 1, wherein the convolution output corresponds to at least one of a matrix multiplication output or a fully connected layer output.

4. The method of claim 1, wherein:
the first set of quantization parameters comprises a first quantization scale and a first zero point, and
the second set of quantization parameters comprises a second quantization scale and a second zero point.

5. The method of claim 4, wherein:
the second set of convolution parameters were quantized according to a third quantization scale and a third zero point, and
the first set of convolution parameters were generated based on:
the first, second, and third quantization scales, and
the third zero point.

6.-8. (canceled)

9. A processor-implemented method, comprising:
accessing a machine learning model architecture comprising a concatenation-convolution sequence that comprises one or more requantization operations to requantize one or more input tensors to a concatenation operation;
generating a modified set of convolution parameters based on:
a set of convolution parameters for a convolution operation of the concatenation-convolution sequence, and
a set of quantization parameters for the one or more input tensors;
quantizing the modified set of convolution parameters; and
generating a modified machine learning model architecture comprising a modified concatenation-convolution sequence that comprises a modified convolution operation using the quantized modified set of convolution parameters.

10. The method of claim 9, wherein during inferencing, a first tensor and a second tensor are processed using the modified concatenation-convolution sequence by:
concatenating the first tensor and the second tensor without requantizing either the first tensor or the second tensor before the concatenating; and
generating a convolution output by processing the concatenated first tensor and second tensor using the modified convolution operation.

11. The method of claim 10, wherein:
the first tensor is quantized according to a first set of quantization parameters, and
the second tensor is quantized according to a second set of quantization parameters.

12. The method of claim 9, wherein the concatenation-convolution sequence implements at least one of a matrix multiplication operation or a fully connected layer operation.

13. The method of claim 9, wherein:
the set of convolution parameters are quantized according to a first quantization scale and a first zero point, and
the set of quantization parameters for the one or more input tensors comprises:
a second quantization scale of a first subset of the set of convolution parameters corresponding to a first tensor of the one or more input tensors, and
a third quantization scale of a second subset of the set of convolution parameters corresponding to a second tensor of the one or more input tensors.

14. The method of claim 13, wherein the modified set of convolution parameters is generated according to \tilde{W}=[S_{W}(W_{q_A}−Z_{W})S_{A}, S_{W}(W_{q_B}−Z_{W})S_{B}], wherein:
\tilde{W} is the modified set of convolution parameters,
S_{W} is the first quantization scale,
W_{q_A} is the first subset of the set of convolution parameters,
Z_{W} is the first zero point,
S_{A} is the second quantization scale,
W_{q_B} is the second subset of the set of convolution parameters, and
S_{B} is the third quantization scale.

15. The method of claim 9, further comprising generating a modified bias for the modified convolution operation based on a bias of the convolution operation, a quantization scale of the modified set of convolution parameters, and a zero point of the modified set of convolution parameters.

16. The method of claim 15, wherein the modified bias is generated according to
$$\text{?} [ o ] = {S}_{\tilde{W}} ( \frac{bias [ o ]}{{S}_{\tilde{W}}} - {Z}_{A} * {\sum }_{i}^{η} ( {\tilde{W}}_{{q}_{\_ Ai}} [ o ] - {Z}_{\tilde{W}} ) - {Z}_{B} * {\sum }_{j}^{m} ( {\tilde{W}}_{q \_ Bj} [ o ] - {Z}_{\tilde{W}} ) ) ,$$
wherein: [symbol]
is the modified bias,
[o] is an output channel index,
bias is the bias of the convolution operation,
S_{\tilde{W}} is the quantization scale of the modified set of convolution parameters,
Z_{A} is a zero point of a first tensor of the one or more input tensors,
\tilde{W}_{q_A} is a first subset of the quantized modified set of convolution parameters corresponding to the first tensor,
Z_{\tilde{W}} is the zero point of the modified set of convolution parameters,
Z_{B} is a zero point of a second tensor of the one or more input tensors, and
\tilde{W}_{q_B} is a second subset of the quantized modified set of convolution parameters corresponding to the second tensor.

17. A processing system, comprising:
a memory comprising computer-executable instructions; and
one or more processors configured to execute the computer-executable instructions and cause the processing system to perform an operation comprising:
concatenating a first quantized tensor quantized according to a first set of quantization parameters and a second quantized tensor quantized according to a second set of quantization parameters to generate a concatenated tensor;
accessing a first set of convolution parameters generated for at least one layer of a first machine learning model based on the first and second sets of quantization parameters and a second set of convolution parameters for at least one layer of a second machine learning model; and
generating a convolution output for the at least one layer of the first machine learning model based on convolving the first set of convolution parameters with the concatenated tensor.

18. The processing system of claim 17, the operation further comprising quantizing the convolution output.

19. The processing system of claim 17, wherein the convolution output corresponds to at least one of a matrix multiplication output or a fully connected layer output.

20. The processing system of claim 17, wherein:
the first set of quantization parameters comprises a first quantization scale and a first zero point, and
the second set of quantization parameters comprises a second quantization scale and a second zero point.

21. The processing system of claim 20, wherein:
the second set of convolution parameters were quantized according to a third quantization scale and a third zero point, and
the first set of convolution parameters were generated based on:
the first, second, and third quantization scales, and
the third zero point.

22. The processing system of claim 21, wherein the first set of convolution parameters were generated according to
\tilde{W}=[S_{W}(W_{q_A}−Z_{W})S_{A}, S_{W}(W_{q_B}−Z_{W})S_{B}], wherein:
\tilde{W} is the first set of convolution parameters,
S_{W} is the third quantization scale,
W_{q_A} is a first subset of the second set of convolution parameters corresponding to the first quantized tensor,
Z_{W} is the third zero point,
S_{A} is the first quantization scale,
W_{q_B} is a second subset of the second set of convolution parameters corresponding to the second quantized tensor, and
S_{B} is the second quantization scale.

23. The processing system of claim 17, wherein:
the first set of convolution parameters were quantized based on a first quantization scale and a first zero point, and
the first set of convolution parameters comprise a first bias generated based on a second bias of the second set of convolution parameters, the first quantization scale, and the first zero point.

24.-30. (canceled)
